(19) United States
(12) Patent Application Publication
(10) Pub. No.: US 2002/0185211 A1
(43) Pub. Date: Dec. 12, 2002

(54) Apparatus for cutting to length a tire tread band

(75) Inventor: Kay Saamer, Darmstadt (DE)

Correspondence Address: ROBERT W. BECKER & ASSOCIATES, Suite B, 707 Highway 66 East, Tijeras, NM, 87059, US

(73) Assignee: A-Z Formen- und Maschinenbau GmbH, Munchen (DE)

(21) Appl. No.: 10/165,785

(22) Filed: Jun. 7, 2002

(30) Foreign Application Priority Data
Jun. 8, 2001 (DE) 101 27 746.6

(51) Int. Cl. B29D 30/08

(52) U.S. Cl. 156/129; 156/406.4

(57) ABSTRACT

An apparatus is provided for cutting to length a tread band which is to be subsequently built up onto a tire carcass. The apparatus includes a transport device for transporting an extent of tread band material from which a tread band is to be cut, and a cutting device for cutting to length a tread band from the extent of tread band material. The apparatus also includes a picture display device for registering and displaying simultaneously a picture of the front end of a tread band after the front end has been cut by the cutting device and a picture of an area of the tread band which lies shortly before and extends to the location at which the back end of the tread band is to be cut by the cutting device.

### BACKGROUND OF THE INVENTION

The present invention relates to an apparatus for cutting to length a tread band or strip, which is to be subsequently built up onto a tire carcass.

A cut-to-length apparatus of the aforementioned type is disclosed in German patent application 100 38 471.4. In a cut-to-length apparatus of this type, the problem exists that the tread bands to be cut to length must invariably be manually measured in order to ensure that the tread bands are accommodated to the respective carcasses of differing diameters on which the tread bands will be laid. The measuring process can also be fraught with errors so that, in many instances, a follow-up control must be performed to ensure the necessary reliability. If a carcass is built up with a tread band which has too short a length, it is, for all practical purposes, not possible to insert a piece of a tread band without incurring a diminishment in quality.

Various processes have been proposed in order to simplify the cutting to length of tread bands. Thus, an apparatus is disclosed in EP-A1-587 650 which measures the extent of the tread band which has already passed by a stop. A disadvantage of this process is that the tread band, being a partially viscous mass, is deformed by this movement including, especially, the movement of the tread band in a curved manner—whereby the length of the tread band is also altered.

### SUMMARY OF THE INVENTION

The present invention offers a solution to the challenge of providing an apparatus for cutting to length a tread band, which will be subsequently built up or laid upon a carcass, whereby the apparatus is characterized by improved reliability and permits a precise registration of the tread band length.

In accordance with the cut-to-length apparatus of the present invention, the length of the tread band is automatically registered and, at the same time, is accommodated to the manufacturing requirements. In this connection, a CCD camera can, for example, be deployed, with the camera being aimed at the cutting region for correspondingly capturing or registering the cut end of the tread band.

In accordance with the present invention, a registration of the extent of the tread band which has already passed a prescribed location is performed by a control apparatus, so that the transport of the tread band via, for example, a type of transport belt, can be captured or registered by an encoder. The desired tread band length, which corresponds to the circumference of the carcass on which the tread band is to be built up on, is now numerically transformed in the control apparatus of the picture displaying apparatus such that an appropriate tread band length is determined which will yield a direct connection between the front end thereof and the back end thereof. This corresponds substantially to the butt joint of a carcass, which has already been built or laid up.

The elongation of the tread band caused by the bending thereof to assume its carcass encircling form can also be compensated for via corresponding calibration, whereby a tread band having a very precise length which permits the build up of the tread band on a carcass with an optimum joint can be produced.

### BRIEF DESCRIPTION OF THE DRAWINGS

Additional advantages, details, and features are set forth in the hereinafter following description of an embodiment of the tread band cut-to-length apparatus of the present invention taken in connection with the figures of the drawing, in which:

FIG. 1 is a schematic view of a tread band and the content of a picture display which displays a picture of the front end of a tread band, if the front end of a tread band has been cut, which is stored by the picture displaying apparatus of the present invention; and

FIG. 2 is a schematic view of a tread band and the content of the picture display in an operating condition shortly before the desired length of the tread band has been reached at which location the back end of the tread band will be cut.

### DETAILED DESCRIPTION OF THE PREFERRED EMBODIMENT

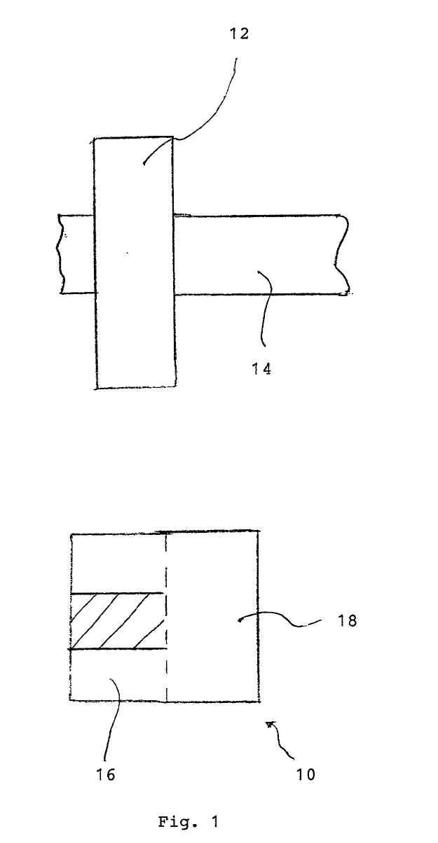

FIG. 1 is a representation of a picture or display 10 of a not-illustrated video capture apparatus for the cut-to-length apparatus of the present invention. The picture is captured or registered via a CCD camera, which captures the image of the region underneath a cutting device 12 that is operable to cut a tread band 14. The cutting device 12 cuts the tread band 14 and, at the location of the cut, a picture is taken by the CCD camera and stored and displayed on the picture screen 10.

The picture screen 10 is divided into a first portion 16 and a second portion 18, which are respectively dedicated to the front and back ends of the tread band 14.

As can be seen in FIG. 1, the picture of the cut tread band is shown in the first picture portion 16 in a 180 degree reversed position.

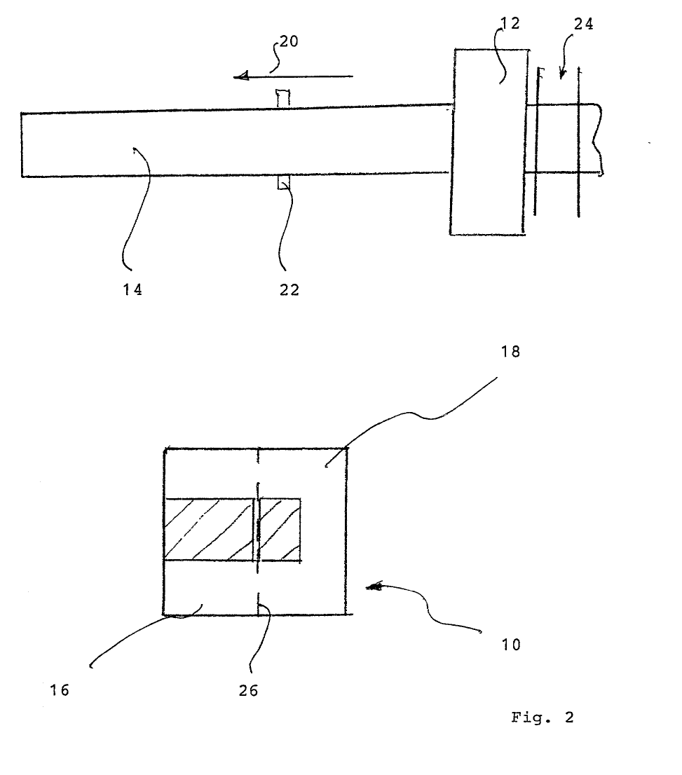

As seen in FIG. 2, the tread band 14 is transported via a transport device in the direction indicated by the arrow 20. A dimension measuring device 22 measures the extent of the tread band which has been transported therepast. As soon as the desired end of the tread band has moved into the region of the cutting device 12, a picture of this portion of the tread band is shown on the second picture portion 18 on the picture screen 10. In this connection, the camera captures the picture of an area 24 of the tread band, which is an area of the tread band substantially bordering on the cutting device 12 lying just before and extending to the location on the tread band at which the cutting device will cut the tread band to create the back end thereof.

The transport device for transporting the tread band is controlled either through operator manipulation or automatically, such that the appropriate position for the actuation of the cutting device 12 is reached. The operator then views the movement of the tread band in the right-hand picture portion 18 on the picture screen 10, and can, for example, undertake the cutting of the back end of the tread band if the two picture samples are congruent. In this connection, a separation line 26 is shown between the picture portions 16 and 18 at an appropriate location on the picture screen.

In accordance with a modification of the preferred embodiment of the cut-to-length apparatus of the present invention, it is provided that the cutting device is, as well, automatically actuable once the desired congruity is present.

According to a further modification of the preferred embodiment of the cut-to-length apparatus of the present invention, the picture screen is configured as a touch screen for permitting control of the transport device, whereby an operator intervention permits an immediate visual feedback.

According to yet another modification of the preferred embodiment of the cut-to-length apparatus of the present invention, which is not further illustrated in detail herein, it is provided that the position of the cutting device 12 can be re-adjusted in connection with the occurrence of shifting tread bands in order to make possible a fine or precise comparison, for example, via the touch screen.

The specification incorporates by reference the disclosure of German priority document 101 27 746.6 filed Jun. 8, 2001.

The present invention is, of course, in no way restricted to the specific disclosure of the specification and drawings, but also encompasses any modifications within the scope of the appended claims.

What is claimed is:

1. A cut-to-length apparatus for cutting to length a tread band which is to be subsequently built up onto a tire carcass, comprising:
a transport device for transporting an extent of tread band material from which a tread band is to be cut;
a cutting device for cutting to length a tread band from the extent of tread band material; and
a picture display device for registering and displaying a picture of the front end of a tread band after the front end has been cut by the cutting device, and a picture of an area of the tread band which lies shortly before and extends to the location at which the back end of the tread band is to be cut by the cutting device, the picture display device preferably displaying the pictures of the front and back ends of the tread band simultaneously.

2. A cut-to-length apparatus according to claim 1, wherein the picture display device comprises a picture screen on which both ends of the tread band are simultaneously displayed.

3. A cut-to-length apparatus according to claim 1, wherein the picture screen of the picture display apparatus comprises a portion for displaying a picture of the front end of the tread band being cut to length, and a portion for displaying a picture of the back end of the tread band.

4. A cut-to-length apparatus according to claim 1, wherein the picture display device includes a memory component by which a picture of the front end of the tread band can be stored and the picture of the front end of the tread band can preferably be continuously displayed in a portion of the picture screen.

5. A cut-to-length apparatus according to claim 1, wherein the picture display device includes a memory component in which is stored the circumference of the carcass on which the tread band being cut to length is to be built up upon, and wherein the picture display device is operable to display a separation line on the picture screen corresponding to the desired length of the tread band.

6. A cut-to-length apparatus according to claim 1, wherein the picture screen of the picture display apparatus comprises a portion for displaying a picture of the front end of the tread band being cut to length and a portion for displaying a picture of the back end of the tread band, the second portion displaying the back end of the tread band in a manner to permit an operator to assess the congruity between the previously cut front end of the tread band picture shown in the first portion of the picture screen and the back end of the tread band.

7. A cut-to-length apparatus according to claim 3, wherein the second portion is configurable, based upon an adjustment of the picture display device, to provide a relatively broad view display and a zoom capability.

8. A cut-to-length apparatus according to claim 1, wherein the picture display device includes a camera for registering a picture of an area of the cutting device located shortly before and extending to the back end of the tread band and, especially, for registering a picture of the cutting area underneath the cutting device.

9. A cut-to-length apparatus according to claim 1, wherein the camera captures a length of the tread band which is less than 20 cm and, especially, is approximately 10 cm.
